(19) United States
(12) Patent Application Publication
(10) Pub. No.: US 2026/0252875 A1
(43) Pub. Date: Aug. 27, 2026

(54) CONTROLLING ACCESS TO INTERNAL KNOWLEDGE IN A LANGUAGE MODEL USING A MIXTURE OF EXPERTS TUNING

(71) Applicant: INTERNATIONAL BUSINESS MACHINES CORPORATION, ARMONK, NY (US)

(72) Inventors: Yair Allouche, Dvira (IL); Matan Levi, Tel Aviv (IL); AVIV RON, klachim (IL); Srinivas Babu Tummalapenta, Broomfield, CO (US)

(21) Appl. No.: 19/062,250

(22) Filed: Feb. 25, 2025

(51) Int. Cl. G06N 3/08; G06F 21/62; G06N 3/045

(52) U.S. Cl. CPC G06N 3/08; G06F 21/6209; G06N 3/045; G06F 2221/2141

(57) ABSTRACT

An approach is provided for access control management. Experts included in a mixture of experts (MoE) architecture are trained. A router selects a set of experts from the MoE model architecture as having greatest probabilities of being relevant to a data point received at the router. An expert in the set is identified as not having a privilege allowing access to the data point. A masking mechanism masks out the identified expert from the selected set of experts and identifies a previously unselected expert that has a next greatest probability of being relevant to the data point. It is determined that the identified previously unselected expert has the privilege allowing access to the data point. Based on the identified previously unselected expert having the privilege allowing the access to the data point, the identified previously unselected expert is added to the selected set of experts.

### BACKGROUND

The present invention relates to information retrieval, and more particularly to managing access control for model-based information retrieval.

### SUMMARY

In one embodiment, the present invention provides a computer-implemented method. The method includes training experts included in a mixture of experts (MoE) model architecture that is enhanced by including a masking mechanism. Each expert is correlated with one or more domains in a dataset or one or more access control list (ACL) privilege groups. The method further includes selecting, by a router in the MoE model architecture, a set of experts from the MoE model architecture as having greatest probabilities of being relevant to a data point received at the router. The method further includes identifying an expert in the set of experts that does not have a privilege allowing access to the data point. The method further includes, based on the identified expert not having the privilege allowing the access to the data point, the masking mechanism masking out the identified expert from the selected set of experts and identifying an expert previously unselected by the router and that has a next greatest probability of being relevant to the data point. The method further includes determining that the identified previously unselected expert has the privilege allowing access to the data point. The method further includes, based on the identified previously unselected expert having the privilege allowing the access to the data point, adding the identified previously unselected expert to the selected set of experts.

A computer system and a computer program product corresponding to the above-summarized computer-implemented method are also described herein.

### BRIEF DESCRIPTION OF THE DRAWINGS

FIG. 1 is a block diagram of a system for controlling access to internal knowledge in a language model using a MoE tuning, in accordance with embodiments of the present invention.

FIG. 2 is a block diagram of modules included in code included in the system of FIG. 1, in accordance with embodiments of the present invention.

FIG. 3 is a flowchart of a process of controlling access to internal knowledge in a language model using a MoE tuning, where operations of the flowchart are performed by modules in FIG. 2, in accordance with embodiments of the present invention.

FIG. 4 is an example of a system using the privilege-based masking mechanism used in the process of FIG. 3, in accordance with embodiments of the present invention.

### DETAILED DESCRIPTION

### Overview

According to an aspect of the present invention, there is provided a computer-implemented method. The method includes training experts included in a mixture of experts (MoE) model architecture that is enhanced by including a masking mechanism. Each expert is correlated with one or more domains in a dataset or one or more access control list (ACL) privilege groups. The method further includes selecting, by a router in the MoE model architecture, a set of experts from the MoE model architecture as having greatest probabilities of being relevant to a data point received at the router. The method further includes identifying an expert in the set of experts that does not have a privilege allowing access to the data point. The method further includes, based on the identified expert not having the privilege allowing the access to the data point, the masking mechanism masking out the identified expert from the selected set of experts and identifying an expert previously unselected by the router and that has a next greatest probability of being relevant to the data point. The method further includes determining that the identified previously unselected expert has the privilege allowing access to the data point. The method further includes, based on the identified previously unselected expert having the privilege allowing the access to the data point, adding the identified previously unselected expert to the selected set of experts. A general technical effect of the aforementioned aspect of the invention is providing access control on the internal knowledge of a language model. Specific technical effects of the aforementioned training the experts and the adding the identified previously unselected expert to the selected set of experts include providing access to different experts based on their access privileges and training a self-restricting model that prevents leakage of data that the model memorized during training. As used herein, a data point is defined as part of data included in input (e.g., part of a user query). A data point can be a token (e.g., a character, a word, or a sub-word) or a set of tokens.

According to another aspect of the present invention, there is provided a computer system that includes a processor set; one or more computer-readable storage media; and program instructions stored on the one or more computer-readable storage media to cause the processor set to perform the operations discussed above relative to the aspect of the invention that provides the method.

According to another aspect of the present invention, there is provided a computer program product that includes one or more computer-readable storage media and program instructions stored on the one or more computer-readable storage media to perform the operations discussed above relative to the aspect of the invention that provides the method.

The computer system and the computer program product each provide general and specific technical effects that include the general and specific technical effects discussed above relative to the aspect of the invention that provides the computer-implemented method.

In embodiments, the aforementioned computer-implemented method further includes (i) generating outputs in response to the data point, where the outputs are generated by the selected set of experts subsequent to adding the identified next expert to the selected set of experts; (ii) determining an access privilege of a user whose input provided the data point; and (iii) sending one or more of the generated outputs to the user, based on the one or more generated outputs having been generated by one or more experts whose privileges match the access privilege of the user. The features described above relative to the aforementioned aspect of the present invention and the features (i), (ii), and (iii) described above provide a management of access control of the dataset within the enhanced MoE model architecture without requiring any components external to the enhanced MoE model architecture. The sending of the one or more outputs to the user based on the matching of the access privilege of the user to the privileges of the one or more experts that generated the one or more outputs provides a specific technical effect of providing access control management of the dataset. The operations discussed in this paragraph are also performed by the processor set in the aforementioned computer system and by the program instructions in the aforementioned computer program product. The specific technical effect discussed in this paragraph is also a specific technical effect provided by each of the aforementioned computer system and the computer program product.

In embodiments, the aforementioned computer-implemented method further includes processing the data point by the selected set of experts, where the processing includes: (i) generating outputs by experts in the selected set of experts, where each output is independently generated by a corresponding one of the experts in the selected set of experts, and (ii) generating a final response by combining the outputs. The features of the aforementioned processing provide a specific technical effect of increasing the efficiency of the MoE model architecture. The operations discussed in this paragraph are also performed by the processor set in the aforementioned computer system and by the program instructions in the aforementioned computer program product. The specific technical effect discussed in this paragraph is also a specific technical effect provided by each of the aforementioned computer system and the computer program product.

In embodiments, the aforementioned computer-implemented method further includes (i) controlling the enhanced MoE model architecture so that one or more MoE layers in the MoE model architecture are preceded by respective one or more shared layers that facilitate a sharing of weights and parameters with all data sources of the dataset; and (ii) routing specific portions of the dataset to specific experts in the one or more MoE layers, but not to other experts, based on ACL privilege groups or specific domains correlated to the specific experts. The aforementioned features involving the controlling of the MoE model architecture and the routing of the specific portions of the dataset provide a specific technical effect of providing a language model trained on all available data sources while also providing user-specific answers based on access privileges. The operations discussed in this paragraph are also performed by the processor set in the aforementioned computer system and by the program instructions in the aforementioned computer program product. The specific technical effect discussed in this paragraph is also a specific technical effect provided by each of the aforementioned computer system and the computer program product.

In embodiments, the aforementioned computer-implemented method further includes learning, by the router and during a training of a language model, that particular data points are passed to corresponding experts, where selecting the set of experts from the MoE model architecture as having the greatest probabilities of being relevant to the data point is based on the learning by the router, and where the router is (i) a linear layer, wherein an output size is a number of possible experts, (ii) a softmax transformation, wherein an output of the linear layer goes through a softmax function, or (iii) a selection based on a probability distribution. The feature of the learning provides a specific technical effect of increasing the efficiency of selecting the set of experts from the MoE model architecture that have the greatest probabilities of being relevant to a data point. The operations discussed in this paragraph are also performed by the processor set in the aforementioned computer system and by the program instructions in the aforementioned computer program product. The specific technical effect discussed in this paragraph is also a specific technical effect provided by each of the aforementioned computer system and the computer program product.

In embodiments, the aforementioned computer-implemented method further includes (i) selecting, by the router, another set of experts from the MoE model architecture as having greatest probabilities of being relevant to another data point received at the router; (ii) identifying an expert in the other set of experts that does not have a privilege allowing access to the other data point; (iii) determining, by the masking mechanism, that there is no next best expert, which is a next expert previously unselected by the router, that has a next greatest probability of being relevant to the other data point, and that has the privilege allowing the access to the other data point; and (iv) based on the identified expert in the other set of experts not having the privilege allowing the access to the other data point and further based on there being no next best expert, the masking mechanism masking out the identified expert from the selected other set of experts and keeping only experts in the selected set of experts that have the privilege allowing the access to the other data point. The features described in this paragraph provide a specific technical effect of managing access control by using a privilege-based masking mechanism added to a MoE model architecture. The operations discussed in this paragraph are also performed by the processor set in the aforementioned computer system and by the program instructions in the aforementioned computer program product. The specific technical effect discussed in this paragraph is also a specific technical effect provided by each of the aforementioned computer system and the computer program product.

In embodiments, the aforementioned computer-implemented method further includes (i) receiving another data point at the router; (ii) determining that the other data point is not data from a specified data source, which indicates that all of the trained experts in the MoE model architecture have the privilege allowing access to the other data point; (iii) selecting, by the router, another set of experts from the MoE model architecture as having greatest probabilities of being relevant to the other data point; and (iv) processing the other data point by the selected other set of experts, without using the masking mechanism. The feature of processing the other data point by the selected set of experts without using the masking mechanism provides a specific technical effect of increasing an efficiency of selecting experts and processing a data point by eliminating a step of using the masking mechanism when the data point is not sensitive data. The operations discussed in this paragraph are also performed by the processor set in the aforementioned computer system and by the program instructions in the aforementioned computer program product. The specific technical effect discussed in this paragraph is also a specific technical effect provided by each of the aforementioned computer system and the computer program product.

As used herein, a specified data source is defined as a repository storing information whose access is restricted to one or more authorized parties. In one embodiment, information in a specified data source can include confidential information (e.g., personally identifiable information), confidential business information (e.g., trade secrets, sales and marketing plans, new product plans, financial data, customer and supplier information, and descriptions of patentable inventions), classified information (e.g., information subject to special security classification regulations imposed by a national government), sensitive information, or any other specific information whose access is restricted. Information in a specified data source does not include public information (e.g., public records available on the Internet). In one embodiment, a specified data source is a sensitive data source.

In embodiments, the aforementioned computer-implemented method further includes passing the data point to the selected set of experts by passing the data point at a token level, a group of tokens level, a sentence level, or a data source level. The feature of passing the data point at a token, sentence or data source level provides a specific technical effect of increasing a flexibility of the enhanced MoE model architecture by increasing a number of types of data points that can be routed. The operations discussed in this paragraph are also performed by the processor set in the aforementioned computer system and by the program instructions in the aforementioned computer program product. The specific technical effect discussed in this paragraph is also a specific technical effect provided by each of the aforementioned computer system and the computer program product.

In embodiments, the aforementioned experts are divided by data source access rights or level confidentiality, where the router is programmatically configured according to a current corporate access control to structured and unstructured data. The feature described in this paragraph provides a specific technical effect of easily and seamlessly incorporating the enhanced MoE model architecture into an existing corporate access control scheme. The operations discussed in this paragraph are also performed by the processor set in the aforementioned computer system and by the program instructions in the aforementioned computer program product. The specific technical effect discussed in this paragraph is also a specific technical effect provided by each of the aforementioned computer system and the computer program product.

In embodiments, the aforementioned computer-implemented method further includes (i) revoking or removing a specific data source by restricting or disabling access to a corresponding expert within the MoE model architecture; and (ii) based on the revocation or removal of the specific data source, preventing a utilization of the revoked or removed data source in a subsequent model operation, thereby performing an unlearning in a language model (LM) in the MoE model architecture, wherein the unlearning causes the LM to forget specific information that the LM previously learned during training. The feature of revoking or removing the specific data source provides a specific technical effect increasing effectiveness and precision of access control by the enhanced MoE model architecture by allowing a corporate entity to precisely control access by certain users to specified data through a configuration of a router. Furthermore, the unlearning feature provides a specific technical effect of facilitating an entity’s compliance with regulations relative to handling personal data or other data from a specified data source.

A particular application of an embodiment of the present invention can include using the computer-implemented method described above to train 40 experts and implement a backbone of an enhanced MoE model architecture so that all of the data sources of a dataset are processed by the backbone, where the data sources include both finance data and research data. Each expert has a corresponding set of privileges indicating what data sources the expert is permitted to access. The 40 experts consist of Expert 1, Expert 2, …, Expert 40. Input related to finance (i.e., a data point related to finance) is received and needs to be passed from the backbone to the experts for processing of the input. The router in the enhanced MoE model architecture selects a set of 8 experts from the 40 experts. The set of 8 experts consists of Expert 1, Expert 2, Expert 15, Expert 19, Expert 24, Expert 27, Expert 35, and Expert 39. The selection of the set of 8 experts is based on the selected experts being determined to be the 8 experts that are most likely to be relevant to the input from the backbone. The router initiates a passing of the input from the backbone to the selected set of 8 experts. A privilege-based masking mechanism in the enhanced MoE model architecture identifies Expert 2 as being an expert in the set of 8 experts that has a privilege of allowing access to a data point related to research, but does not have a privilege of allowing access to a data point related to finance. The privilege-based masking mechanism masks out Expert 2 (so Expert 2 is no longer part of the selected set of 8 experts) and identifies Expert 17 as being the next best (and previously unselected) expert included in the 40 experts, where “next best” indicates the expert that is the next most likely to be relevant to the input. The masking mechanism determines that Expert 17 has the privilege allowing access to a data point related to finance. Based on Expert 17 having the privilege allowing access to a data point related to finance, the masking mechanism adds Expert 17 to the selected set of 8 experts (i.e., so that Expert 17 replaces the masked out Expert 2 in the set of 8 experts). Furthermore, the masking mechanism determines that the other experts in the initial selected set of 8 experts (i.e., Expert 1, Expert 15, Expert 19, Expert 24, Expert 27, Expert 35, and Expert 39) have the privilege of allowing access to a data point related to finance, so there are no further masking out actions and the final selected set of 8 experts consists of Expert 1, Expert 15, Expert 17, Expert 19, Expert 24, Expert 27, Expert 35, and Expert 39. The masking mechanism completes the passing of the input from the backbone by passing the input to Expert 1, Expert 15, Expert 17, Expert 19, Expert 24, Expert 27, Expert 35, and Expert 39. With the privilege-based masking mechanism, the enhanced MoE model architecture guarantees that Expert 2 will never see any finance-related data.

A common scenario includes fine-tuning a language model using diverse data sources. Users have varying access rights or privileges to access these data sources. A conventional approach to restrict or control access to the different knowledge bases used to train a foundation model includes training models for each knowledge base. The training of foundation models is highly expensive and a time-consuming process. Furthermore, a conventional approach that forces a particular model to generate an answer based only on retrieved data does not prevent leakage of data that the model memorized during training. Still further, known work in the field of foundation models addresses only a narrow scope of safety issues related to LMs, such as bias, Hate Abuse Profanity (HAP), and adversarial attacks. Moreover, known techniques related to conditional MoE (i.e., enhanced routing based on specific task or modality) are limited because they fail to handle access control management directly within a foundation model.

Embodiments of the present invention address the aforementioned unique challenges by training an LM on diverse data sources while adding an access control mechanism for mitigating the risk that the LM exposes enterprise information from specified data sources (e.g., sensitive enterprise information) to users who lack the appropriate privileges to access the information. As used herein, a LM is defined as a probabilistic model of a natural language that can be used for a variety of tasks, including natural language generation whereby a response is generated to answer a user query. A LM can acquire the natural language generation abilities by, for example, learning statistical relationships from large amounts of text during a self-supervised and semi-supervised training process. As used herein, a LM can be a large language model or a small language model. Hereinafter, the LM is also referred to simply as the model. As used herein, a privilege (or access privilege) of a user is a specific permission granted to a user that allows the user to access certain documents and perform certain actions on the accessed documents and to obtain output from certain experts included in the enhanced MoE model architecture, where the certain experts have been assigned a privilege that matches the privilege of the user.

Embodiments of the present invention provide an enhanced MoE model architecture-based method for implementing access control on the internal knowledge of a LM, thereby allowing the LM to provide user-specific responses based on individual privileges and access rights, even though the LM has been trained on a set of data sources having diverse privileges. For example, the LM is fine-tuned with diverse data sources, while users have varying levels of access to the data sources. As used herein, an access right is a specific permission granted to a user that allows the user to perform particular actions on a document, such as reading, modifying, deleting, or commenting on the document.

In one embodiment, the access control system disclosed herein is provided for LMs trained using diverse data sources, where users have varying access rights or privileges to these data sources. The access control system adjusts a conventional MoE model architecture in a way that enables access to different experts of the model, based on the experts’ privileges and access rights. This approach enables the model to provide user-specific answers based on the users’ privileges and access rights, while the model is trained on all available data sources.

In one embodiment, the access control system disclosed herein implements an enhanced MoE model architecture, which includes multiple neural networks as experts integrated in the network. In one embodiment, the aforementioned neural networks are feed-forward neural networks (FFNs). Each expert is correlated to a different domain the in the dataset and/or a different ACL group.

In one embodiment, at inference time, the access control system disclosed herein provides the user with output from experts whose assigned privilege matches the user’s access privilege.

Embodiments of the present invention address an additional domain of safety of LMs, which broadens the narrow scope of safety issues in conventional approaches. The additional domain of safety includes a method disclosed herein for managing cybersecurity access management directly from within the foundation model.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

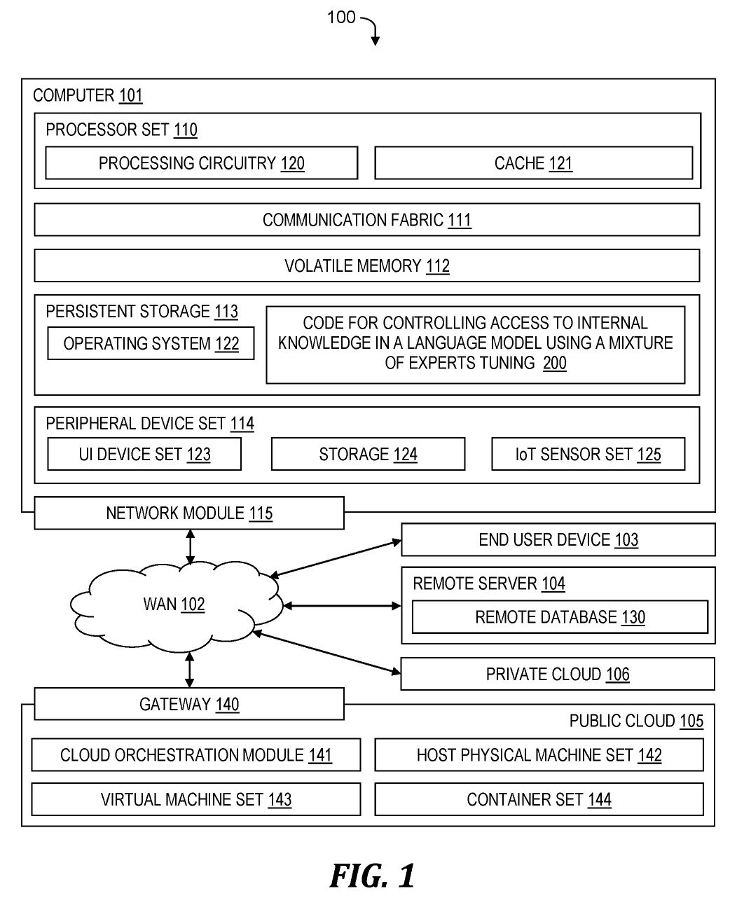

FIG. 1 is a block diagram of a system for controlling access to internal knowledge in a language model using a MoE tuning, in accordance with embodiments of the present invention. Computing environment 100 contains an example of an environment for the execution of at least some of the computer code involved in performing the inventive methods, such as code 200 for controlling access to internal knowledge in a language model using a MoE tuning. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Controlling Access to Internal Knowledge in a Language Model Using a MoE Tuning

The MoE architecture is an approach for building LMs that address challenges such as computational cost and model size. An LM built using an MoE architecture is also referred to herein as an LM using a MoE tuning.

Unlike traditional LMs with a single, monolithic structure, MoE architecture-based LMs include multiple smaller sub-models called “experts,” each specializing in handling a specific type of input. A MoE architecture-based LM is also referred to herein as a MoE model architecture.

Each expert in the MoE architecture independently performs its own computation, and the experts’ results are combined to produce the final output of a MoE layer in the MoE architecture. MoE architectures can be categorized as either dense (i.e., every expert is utilized for every input) or sparse (i.e., only a subset of experts is utilized for each input).

When presented with an input, a MoE architecture-based LM first routes the information through a gating network (i.e., a router), which acts like a smart switch, deciding which experts are best suited for a particular task. The chosen experts then process the input independently to generate respective outputs, and the outputs are combined to generate a final response. This routing through a gating network and processing the input independently allows the MoE architecture-based LM to be more efficient and in some cases more powerful than traditional models.

In other embodiments, the experts (and the router) can be divided in a more generalized manner: by data sources access rights, by level confidentiality, etc. The router can be programmatically configured per the current corporate access control to structured and unstructured data.

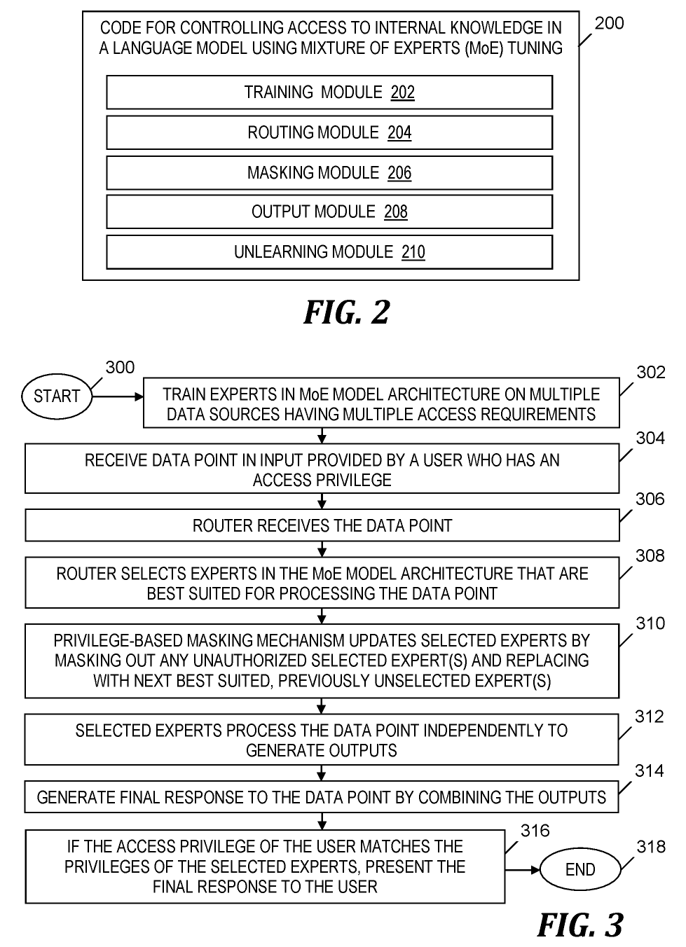

FIG. 2 is a block diagram of modules included in code 200 included in the system of FIG. 1, in accordance with embodiments of the present invention. Code 200 includes a training module 202, a routing module 204, a masking module 206, an output module 208, and an unlearning module 210.

Training module 202 is configured to train experts included in an enhanced MoE model architecture that includes a router and a masking mechanism. Each expert is correlated with a different domain in a dataset or a different ACL privilege group (or a combination of a domain and an ACL privilege group).

The enhanced MoE model architecture is trained on all available data sources. To allow the enhanced MoE model architecture to be trained on all available data sources, while still providing user-specific answers based on the users’ privileges and access rights, the access control system disclosed herein controls the enhanced MoE model architecture so that the backbone of the enhanced MoE model architecture shares its weights and parameters with all data sources, while the router routes to each expert a specific portion of the dataset, based on ACL privilege groups, specific datasets, specific domains, etc.

Routing module 204 is configured to select a set of experts from the MoE model architecture as having the greatest probabilities of being relevant to a data point received by routing module 204. In one embodiment, routing module 204 acts like a smart switch, deciding which experts are best suited for a particular task related to input received by routing module 204. The deciding of which experts is performed by a learned routing mechanism (also referred to herein as a router), which is integrated within the MoE model architecture. In one embodiment, routing module 204 is implemented in the router.

The routing mechanism can be, for example, (i) a linear layer, where the output size is the number of possible experts, (ii) a softmax transformation, where the output of the linear layer goes through a softmax function, or (iii) a selection based on the probability distribution.

Masking module 206 is configured to (i) identify an expert in the set of experts selected by routing module 204 that does not have a privilege allowing access to a data point received by the router; (ii) mask out the identified expert from the set of experts selected by routing module 204, so the identified expert is no longer included in the set of experts and cannot access the data point; (iii) identify a next best expert previously unselected by the routing module 204, which has a next greatest probability of being relevant to the data point; (iv) determine that the identified next best expert has the privilege allowing access to the data point; and (v) add the identified next best expert to the selected set of experts.

Masking module 206 is an enhancement to the routing provided by routing module 204. The masking provided by masking module 206 is also called privilege-based masking. The operations of masking module 206 are performed immediately after the routing provided by routing module 204.

Output module 208 is configured to (i) generate outputs in response to experts in the selected set of experts processing the data point, where the selected set of experts is subsequent to the adding of the identified next best expert; (ii) determining an access privilege of the user whose input provided the data point; and (iii) sending one or more of the outputs to the user, based on the one or more generated outputs being generated by one or more experts whose privileges match the access privilege of the user.

The features provided by training module 202, routing module 204, masking module 206, and output module 208 provide a management of access control of a dataset within the enhanced MoE model architecture without requiring any external components (i.e., components external to the enhanced MoE model architecture).

Unlearning module 210 is configured to revoke or remove specific data sources by restricting or disabling access to a corresponding expert within the MoE model architecture, thereby effectively preventing the utilization of the revoked or removed data in subsequent model operations, which is a process of making the model unlearn or “forget” specific information that the model has learned during training. The router can be configured with data parameters that indicate the users should not gain access to the revoked or removed data. The unlearning feature can be programmatically enabled based on individual or a corporate entity’s objection. The unlearning feature can also facilitate compliance with regulations, such as General Data Protection Regulation (GDPR).

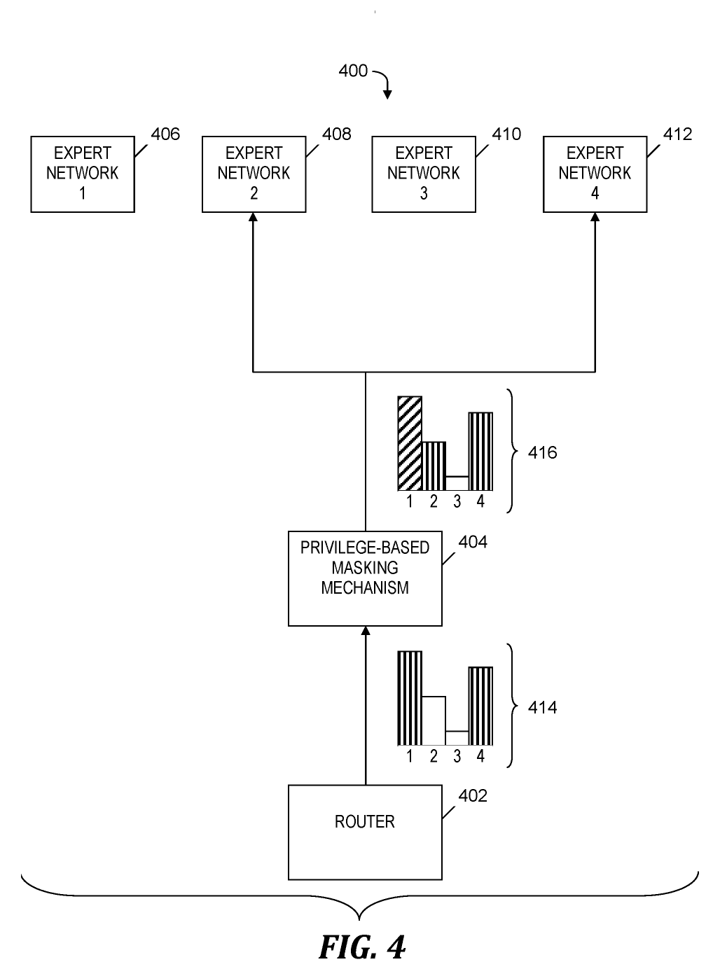

The functionality of the modules included in code 200 is described in more detail in the discussions presented below relative to FIGS. 3 and 4.

FIG. 3 is a flowchart of a process of controlling access to internal knowledge in a language model using a MoE tuning, where operations of the flowchart are performed by modules in FIG. 2, in accordance with embodiments of the present invention. The process of FIG. 3 begins at a start node 300. In step 302, training module 202 trains experts included in an enhanced MoE model architecture on multiple data sources having multiple access requirements, where users have varying access privileges to the data sources. Each expert is correlated with a different domain in a dataset that includes the data sources, a different ACL privilege group, or a different combination of a domain and an ACL privilege group.

In step 304, a data point receipt module (not shown in FIG. 2) receives a data point within input provided by a user who has an access privilege.

In step 306, routing module 204 receives the data point.

In step 308, routing module 204 selects experts in the MoE model architecture that are best suited for processing the data point. The experts selected in step 308 are also referred to herein as the selected set of experts or simply the selected experts. That is, routing module 204 selects the m experts from all the experts in the MoE model architecture, where the m experts have respective m greatest probabilities of the expert being relevant to the data point, and where m is an integer greater than or equal to one. In one embodiment, a router described herein implements the routing module 204.

In step 310, masking module 206 updates the experts selected in step 308 by masking out any unauthorized selected expert(s) and replacing the masked out expert(s) with respective next best suited expert(s) which were previously left unselected by the selections in step 308 (i.e., previously unselected expert(s) which have the next greatest probabilities of being relevant to the data point). As used herein, an unauthorized selected expert is an expert included in the selected experts that does not have a privilege allowing access to the data point. In one embodiment, a privilege-based masking mechanism described herein implements the masking module 206.

In one embodiment, masking module 206 in step 310 identifies an expert included in the selected experts, where the identified expert does not have a privilege allowing access to the data point received in step 306. Also in step 310 and based on the identified expert not having the privilege allowing access to the data point, masking module 206 masks out the identified expert from the selected experts and identifies an expert that was previously unselected by the routing module 204 in step 308. To identify the previously unselected expert, masking module 206 identifies an expert included in the MoE model architecture that has the next greatest probability of being relevant to the data point.

In step 312, the selected experts process the data point independently to generate respective outputs. If no updating occurred in step 310, then the selected experts in step 312 are the experts selected in step 308. If updating occurred in step 310, then the selected experts in step 312 are the selected experts resulting from the update in step 310. Output module 208 receives the outputs generated in step 312.

In step 314, output module 208 generates a final response to the data point by combining the outputs generated in step 312.

In step 316, output module 208 determines whether the access privilege of the user matches privileges of the selected experts described in step 312. If the access privilege of the user matches the privileges of the selected experts described in step 312, then output module 208 presents the final response to the user. If the access privilege of the user does not match the privileges of the selected experts described in step 312, then output module 208 prevents a presentation of the final response to the user.

In one embodiment, output module 208 in step 316 knows the access privileges of the user, and allows the user to receive output only from experts whose ACL group privileges are relevant to the user’s access privileges (i.e., output module 208 allows the user to receive output from experts that see data that the user is privileged to access).

Following step 316, the process of FIG. 3 ends at an end node 318.

In one embodiment, unlearning module 210 performs an unlearning process (not shown in FIG. 3) in the MoE model architecture that includes (i) revoking or removing a specific data source by restricting or disabling access to a corresponding expert within the MoE model architecture; and (ii) based on the revocation or removal of the specific data source, preventing a utilization of the revoked or removed data source in a subsequent model operation. The unlearning process performed by unlearning module 210 causes the LM to “forget” specific information that the LM previously learned during training. The router that implements routing module 204 can be configured with data parameters indicating that the users cannot gain access to the revoked or removed data. The unlearning process can be programmatically enabled based on an individual or a corporate entity’s objection. The unlearning process can facilitate a compliance with a regulation, such as GDPR.

As one example of the process of FIG. 3, consider that the number of experts in the MoE model architecture is equal to the number of ACL groups, which is k. Each expert can see data only if the piece of data is within the expert’s ACL group privileges. A new piece of data is received in step 304 as part of input provided by a user, and is received by the router in step 306. In response to receiving the new piece of data in step 304, the router in step 308 chooses m experts from the aforementioned k experts, where m is less than or equal to k.

If within the m experts (i.e., the chosen experts) there is an unauthorized expert whose ACL group privileges do not include a privilege to access the new piece of data, then the privilege-based masking mechanism in step 310 masks out the unauthorized expert and identifies a previously unchosen expert, which is allowed to process the new piece of data. The privilege-based masking mechanism in step 310 removes the masked out unauthorized expert from the chosen experts and adds the identified previously unchosen expert to the chosen experts.

If no previously unchosen expert exists (where the previously unchosen expert has a next highest probability of being relevant to the new piece of data), then the privilege-based masking mechanism keeps only those experts in the chosen experts that are allowed to process the new piece of data and masks out any unauthorized expert(s).

If the data is not sensitive (i.e., all the experts are allowed to see the data), the masking mechanism allows the router to select the experts without any updating done by the masking mechanism.

The privilege-based masking performed by the masking mechanism is not limited and can be at a token level, a data source level, a sentence level, etc.

The process of FIG. 3 allows the LM to see and learn from all of the data sources within the dataset, but still restrict access to data when the restriction is needed.

FIG. 4 is an example of a system 400 using a privilege-based masking mechanism used in the process of FIG. 3, in accordance with embodiments of the present invention. System 400 includes a router 402, a privilege-based masking mechanism 404, and four experts: expert network 406, expert network 408, expert network 410, and expert network 412 (also referred to as expert network 1, expert network 2, expert network 3, and expert network 4, respectively).

Router 402 receives a data point in step 306 and initially selects expert network 1 and expert network 4 in step 308, as the experts best suited for processing the data point. A bar chart 414 indicates the selections of expert network 1 and expert network 4 by the bars labeled 1 and 4 being filled in with the vertical line pattern. The labels 1, 2, 3, and 4 in bar chart 414 indicate the expert networks 1 through 4, respectively. Bar chart 414 and bar chart 416 each indicates relative suitability for processing the data point by the relative heights of the bars. For example, the top two experts in terms of suitability to process the data point are indicated by the two tallest bars in bar chart 414: the bar labeled 1 (indicating expert network 1) and the bar labeled 4 (indicating expert network 4).

In step 310, privilege-based masking mechanism 404 identifies expert network 1 as being an unauthorized expert (i.e., an expert that does not have the privilege to access the data point) and in response, masks out expert network 1. Furthermore, in step 310, privilege-based masking mechanism 404 identifies the next best expert network that has not yet been selected (i.e., the expert network indicated by the next (third) tallest bar in bar chart 414, which is the bar placed second from the left in bar chart 414, which indicates expert network 2). Privilege-based masking mechanism 404 adds the identified next best expert network 2 to an updated set of selected experts in step 310, as indicated in a bar chart 416. The masked out expert network 1 is indicated by the diagonal line pattern and the two currently selected experts are the expert networks 2 and 4, as indicated by the vertical line patterns. In step 312, the data point is passed to the currently selected experts: expert network 2 and expert network 4, which subsequently process the data point to generate outputs.

The descriptions of the various embodiments of the present invention have been presented herein for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
training experts included in a mixture of experts (MoE) model architecture that is enhanced by including a masking mechanism, each expert being correlated with one or more domains in a dataset or one or more access control list (ACL) privilege groups.
selecting, by a router in the MoE model architecture, a set of experts from the MoE model architecture as having greatest probabilities of being relevant to a data point received at the router;
identifying an expert in the set of experts that does not have a privilege allowing access to the data point;
based on the identified expert not having the privilege allowing the access to the data point, the masking mechanism masking out the identified expert from the selected set of experts and identifying an expert previously unselected by the router and that has a next greatest probability of being relevant to the data point;
determining that the identified previously unselected expert has the privilege allowing access to the data point; and
based on the identified previously unselected expert having the privilege allowing the access to the data point, adding the identified previously unselected expert to the selected set of experts.

2. The method of claim 1, further comprising:
generating outputs in response to the data point, the outputs being generated by the selected set of experts subsequent to the adding the identified previously unselected expert to the selected set of experts;
determining an access privilege of a user whose input provided the data point; and
sending one or more of the generated outputs to the user, based on the one or more generated outputs being generated by one or more experts whose privileges match the access privilege of the user,
wherein the training, the selecting the set of experts, the identifying the expert that does not have the privilege, the masking out the identified expert, the identifying the previously unselected expert, the determining that the identified previously unselected expert has the privilege, the adding the identified previously unselected expert, the generating the outputs, the determining the access privilege of the user, and the sending the one or more of the generated outputs to the user provide a management of access control of the dataset within the enhanced MoE model architecture without requiring any components external to the enhanced MoE model architecture.

3. The method of claim 1, further comprising:
processing the data point by the selected set of experts, wherein the processing includes:
generating outputs by experts in the selected set of experts, each output being independently generated by a corresponding one of the experts in the selected set of experts, and
generating a final response by combining the outputs.

4. The method of claim 1, further comprising:
controlling the enhanced MoE model architecture so that one or more MoE layers in the MoE model architecture are preceded by respective one or more shared layers that facilitate a sharing of weights and parameters with all data sources of the dataset; and
routing specific portions of the dataset to specific experts in the one or more MoE layers, but not to other experts, based on ACL privilege groups or specific domains correlated to the specific experts.

5. The method of claim 1, further comprising:
learning, by the router and during a training of a language model, that particular data points are passed to corresponding experts, wherein the selecting the set of experts from the MoE model architecture as having the greatest probabilities of being relevant to the data point is based on the learning by the router, and wherein the router is (i) a linear layer, wherein an output size is a number of possible experts, (ii) a softmax transformation, wherein an output of the linear layer goes through a softmax function, or (iii) a selection based on a probability distribution.

6. The method of claim 1, further comprising:
selecting, by the router, another set of experts from the MoE model architecture as having greatest probabilities of being relevant to another data point received at the router;
identifying an expert in the other set of experts that does not have a privilege allowing access to the other data point;
determining, by the masking mechanism, that there is no expert previously unselected by the router, which has a next greatest probability of being relevant to the other data point, and that has the privilege allowing the access to the other data point; and
based on the identified expert in the other set of experts not having the privilege allowing the access to the other data point and further based on there being no previously unselected expert, the masking mechanism masking out the identified expert from the selected other set of experts and keeping only experts in the selected set of experts that have the privilege allowing the access to the other data point.

7. The method of claim 1, further comprising:
receiving another data point at the router;
determining that the other data point is not data from a specified data source, which indicates that all of the trained experts in the MoE model architecture have the privilege allowing access to the other data point;
selecting, by the router, another set of experts from the MoE model architecture as having greatest probabilities of being relevant to the other data point; and
processing the other data point by the selected other set of experts, without using the masking mechanism.

8. The method of claim 1, further comprising:
passing the data point to the selected set of experts by passing the data point at a token level, a group of tokens level, a sentence level, or a data source level.

9. The method of claim 1, wherein the experts are divided by data source access rights or level confidentiality, and wherein the router is programmatically configured according to a current corporate access control to structured and unstructured data.

10. The method of claim 1, further comprising:
revoking a specific data source by restricting or disabling access to a corresponding expert within the MoE model architecture; and
based on the revocation of the specific data source, preventing a utilization of the revoked data source in a subsequent model operation, thereby performing an unlearning in a language model (LM) in the MoE model architecture, wherein the unlearning causes the LM to forget specific information that the LM previously learned during training.

11. A computer system comprising:
a processor set;
one or more computer-readable storage media; and
program instructions stored on the one or more computer-readable storage media to cause the processor set to perform operations comprising:
training experts included in a mixture of experts (MoE) model architecture that is enhanced by including a masking mechanism, each expert being correlated with one or more domains in a dataset or one or more access control list (ACL) privilege groups;
selecting, by a router in the MoE model architecture, a set of experts from the MoE model architecture as having greatest probabilities of being relevant to a data point received at the router;
identifying an expert in the set of experts that does not have a privilege allowing access to the data point;
based on the identified expert not having the privilege allowing the access to the data point, the masking mechanism masking out the identified expert from the selected set of experts and identifying an expert previously unselected by the router and that has a next greatest probability of being relevant to the data point;
determining that the identified previously unselected expert has the privilege allowing access to the data point; and
based on the identified previously unselected expert having the privilege allowing the access to the data point, adding the identified previously unselected expert to the selected set of experts.

12. The computer system of claim 11, wherein the operations further comprise:
generating outputs in response to the data point, the outputs being generated by the selected set of experts subsequent to the adding the identified previously unselected expert to the selected set of experts;
determining an access privilege of a user whose input provided the data point; and
sending one or more of the generated outputs to the user, based on the one or more generated outputs being generated by one or more experts whose privileges match the access privilege of the user,
wherein the training, the selecting the set of experts, the identifying the expert that does not have the privilege, the masking out the identified expert, the identifying the previously unselected expert, the determining that the identified previously unselected expert has the privilege, the adding the identified previously unselected expert, the generating the outputs, the determining the access privilege of the user, and the sending the one or more of the generated outputs to the user provide a management of access control of the dataset within the enhanced MoE model architecture without requiring any components external to the enhanced MoE model architecture.

13. The computer system of claim 11, wherein the operations further comprise:
processing the data point by the selected set of experts, wherein the processing includes:
generating outputs by experts in the selected set of experts, each output being independently generated by a corresponding one of the experts in the selected set of experts, and
generating a final response by combining the outputs.

14. The computer system of claim 11, wherein the operations further comprise:
controlling the enhanced MoE model architecture so that one or more MoE layers in the MoE model architecture are preceded by respective one or more shared layers that facilitate a sharing of weights and parameters with all data sources of the dataset; and
routing specific portions of the dataset to specific experts in the one or more MoE layers, but not to other experts, based on ACL privilege groups or specific domains correlated to the specific experts.

15. The computer system of claim 11, wherein the operations further comprise:
learning, by the router and during a training of a language model, that particular data points are passed to corresponding experts, wherein the selecting the set of experts from the MoE model architecture as having the greatest probabilities of being relevant to the data point is based on the learning by the router, and wherein the router is (i) a linear layer, wherein an output size is a number of possible experts, (ii) a softmax transformation, wherein an output of the linear layer goes through a softmax function, or (iii) a selection based on a probability distribution.

16. A computer program product comprising:
one or more computer-readable storage media; and
program instructions stored on the one or more computer-readable storage media to perform operations comprising:
training experts included in a mixture of experts (MoE) model architecture that is enhanced by including a masking mechanism, each expert being correlated with one or more domains in a dataset or one or more access control list (ACL) privilege groups;
selecting, by a router in the MoE model architecture, a set of experts from the MoE model architecture as having greatest probabilities of being relevant to a data point received at the router;
identifying an expert in the set of experts that does not have a privilege allowing access to the data point;
based on the identified expert not having the privilege allowing the access to the data point, the masking mechanism masking out the identified expert from the selected set of experts and identifying an expert previously unselected by the router and that has a next greatest probability of being relevant to the data point;
determining that the identified previously unselected expert has the privilege allowing access to the data point; and
based on the identified previously unselected expert having the privilege allowing the access to the data point, adding the identified previously unselected expert to the selected set of experts.

17. The computer program product of claim 16, wherein the operations further comprise:
generating outputs in response to the data point, the outputs being generated by the selected set of experts subsequent to the adding the identified previously unselected expert to the selected set of experts;
determining an access privilege of a user whose input provided the data point; and
sending one or more of the generated outputs to the user, based on the one or more generated outputs being generated by one or more experts whose privileges match the access privilege of the user,
wherein the training, the selecting the set of experts, the identifying the expert that does not have the privilege, the masking out the identified expert, the identifying the previously unselected expert, the determining that the identified previously unselected expert has the privilege, the adding the identified previously unselected expert, the generating the outputs, the determining the access privilege of the user, and the sending the one or more of the generated outputs to the user provide a management of access control of the dataset within the enhanced MoE model architecture without requiring any components external to the enhanced MoE model architecture.

18. The computer program product of claim 16, wherein the operations further comprise:
processing the data point by the selected set of experts, wherein the processing includes:
generating outputs by experts in the selected set of experts, each output being independently generated by a corresponding one of the experts in the selected set of experts, and
generating a final response by combining the outputs.

19. The computer program product of claim 16, wherein the operations further comprise:
controlling the enhanced MoE model architecture so that one or more MoE layers in the MoE model architecture are preceded by respective one or more shared layers that facilitate a sharing of weights and parameters with all data sources of the dataset; and
routing specific portions of the dataset to specific experts in the one or more MoE layers, but not to other experts, based on ACL privilege groups or specific domains correlated to the specific experts.

20. The computer program product of claim 16, wherein the operations further comprise:
learning, by the router and during a training of a language model, that particular data points are passed to corresponding experts, wherein the selecting the set of experts from the MoE model architecture as having the greatest probabilities of being relevant to the data point is based on the learning by the router, and wherein the router is (i) a linear layer, wherein an output size is a number of possible experts, (ii) a softmax transformation, wherein an output of the linear layer goes through a softmax function, or (iii) a selection based on a probability distribution.
